(19) United States
(12) Patent Application Publication
(10) Pub. No.: US 2014/0143673 A1
(43) Pub. Date: May 22, 2014

(54) CLOUD HMI SYSTEM

(71) Applicant: WEINTEK LABS., INC., New Taipei City (TW)

(72) Inventor: Shih-Chien HSIEH, New Taipei City (TW)

(73) Assignee: Weintek Labs., Inc., New Taipei City (TW)

(21) Appl. No.: 13/752,899

(22) Filed: Jan. 29, 2013

Related U.S. Application Data
(60) Provisional application No. 61/728,523, filed on Nov. 20, 2012.

(51) Int. Cl. G06F 3/0484

(52) U.S. Cl. CPC G06F 3/0484
USPC 715/736

(57) ABSTRACT

A cloud human-machine interface (HMI) system includes an interactive panel for executing user interface tasks along with one or more cloud HMI servers for executing communication interface tasks and background tasks. The interactive panel and the cloud HMI server are connected via a network.

### CROSS-REFERENCE TO RELATED APPLICATIONS

This application claims the benefit of U.S. Provisional Application No. 61/728,523 (Att. Docket WE8742PR), filed on Nov. 20, 2012 and entitled “CloudHMI,” the entire contents of which are incorporated herein by reference.

### BACKGROUND OF THE INVENTION

1. Field of the Invention

The present invention generally relates to a user interface, and more particularly to a cloud human-machine interface (HMI) system.

2. Description of Related Art

Human-machine interface (HMI) is commonly used as a medium to exchange information between humans and machines. Data retrieved from machines may, for example, be interpreted as numeric digits, symbols, text, graphic or curve, so that humans can recognize operation status of the machines. The operation data may further be stored in HMI storage as historical data for future reference, and alarm or abnormal conditions may be set to facilitate automatic HMI tracking machine status and notifying the operator through visual display or message. Humans may issue commands that are then sent to the machines by HMI based on machine status.

FIG. 1 shows a block diagram illustrative of a conventional HMI 1. The HMI 1 is composed of a liquid crystal display (LCD) 11, a touch panel 12 and a central processing unit (CPU) board 13. An operator maneuvers the HMI 1 to monitor and control a machine (not shown) via a machine controller 14.

Each machine demands one HMI 1, and each HMI 1 requires one set of LCD 11 and touch panel 12. Moreover, as the HMI 1 is normally disposed near or in the machine to be monitored/controlled, the operator typically must go to each machine and operate dedicated HMI installed near or in each machine.

Some machine operation environments require extended temperature ranges, such as −20° C. The LCDs 11 and touch panels 12 as commonly made, however, can only endure zero to 50° C. operation temperatures. Therefore it is difficult for HMI 1 to operate in −20° C. environment without the LCDs 11 and touch panels 12 of the conventional HMI 1 being manufactured in a more advanced process to meet their requirements for below zero environments.

A need has thus arisen to propose a novel cloud HMI system for overcoming the disadvantages of the conventional HMI 1.

### SUMMARY OF THE INVENTION

In view of the foregoing, it is an object of the embodiment of the present invention to provide a cloud human-machine interface (HMT) system to substantially lower costs by eliminating components such as LCDs and touch panels. The embodiment also enables an operator to remotely monitor and control multiple machines and switch among the multiple machines, through a single interactive panel without subjection to harsh environments.

According to one embodiment, a cloud human-machine interface (HMI) system includes an interactive panel, at least one cloud HMI server, and a network. The interactive panel is configured to execute user interface tasks. The cloud HMI server is configured to execute communication interface tasks and background tasks. The interactive panel and the cloud HMI server are connected via the network.

### BRIEF DESCRIPTION OF THE DRAWINGS

FIG. 1 shows a block diagram illustrative of a conventional HMI;

FIG. 2 shows a block diagram illustrative of a cloud HMI system according to one embodiment of the present invention;

FIG. 3 shows a detailed block diagram of the interactive panel of FIG. 2;

FIG. 4 shows a detailed block diagram, from a hardware perspective, of the cloud HMI server of FIG. 2;

FIG. 5 shows a detailed block diagram, from a software perspective, of the cloud HMI server of FIG. 2;

FIG. 6 shows an exemplary search interface of the GUI of FIG. 5; and

FIG. 7 shows a flow diagram illustrative of operation sequence of the cloud HMI system of FIG. 2.

### DETAILED DESCRIPTION OF THE INVENTION

FIG. 2 shows a block diagram illustrative of a cloud human-machine interface (HMI) system 2 according to one embodiment of the present invention. In the embodiment, the cloud HMI system 2 includes an interactive panel 21 and at least one cloud HMI server 22. Although one interactive panel 21 is depicted in the drawing, it is appreciated that more than one interactive panel 21 may be used in the cloud HMI system 2. The interactive panel 21 primarily executes user interface (particularly graphical user interface or GUI) tasks, and the cloud HMI server 22 primarily executes communication interface tasks and background tasks.

The cloud HMI server 22 and the interactive panel 21 may be connected via a network 23 such as Wi-Fi (IEEE 802.11) or Ethernet. The network 23 in general may be a wired computer network or a wireless computer network. As shown in FIG. 2, each cloud HMI server 22 may be connected to an associated machine controller 24, such as a programmable logic controller (PLC), which further controls an associated machine (not shown).

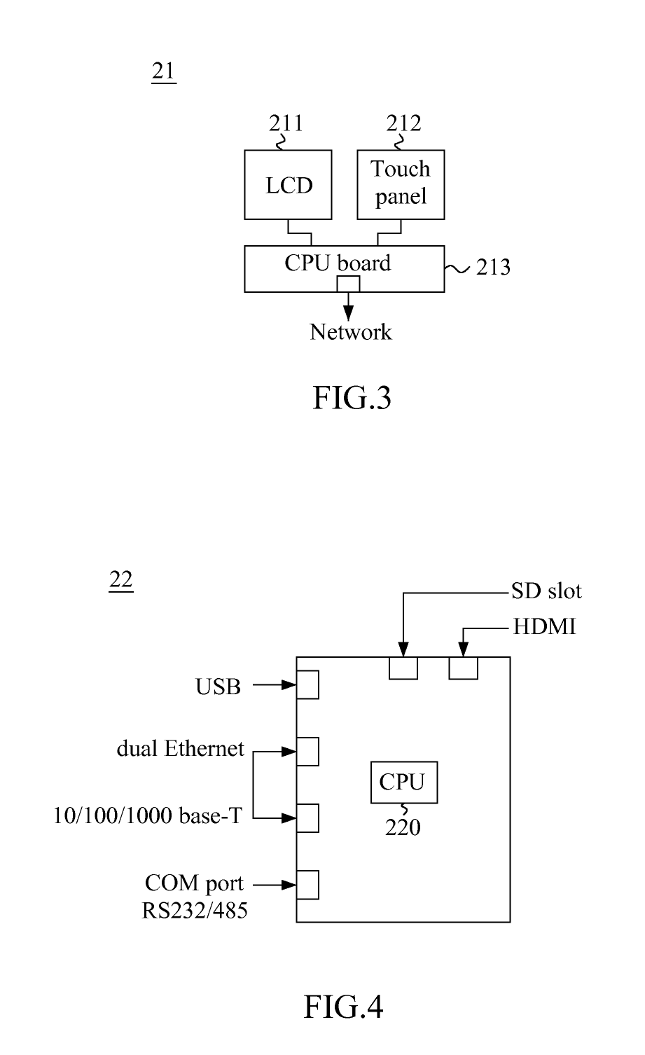

FIG. 3 shows a detailed block diagram of the interactive panel 21 of FIG. 2. As shown in FIG. 3, the interactive panel 21 of the embodiment includes a display (e.g., a liquid crystal display or LCD) 211, an input device (e.g., a touch panel) 212 and a processing board (e.g., a central processing unit (CPU) board) 213. The processing board 213 couples with the display 211 and the input device 212. Specifically, the LCD 211 and the touch panel 212 combine to form a touchscreen, via which an operator is facilitated or enabled to observe the status of machine operation and/or send commands to control the machine(s).

FIG. 4 shows a detailed block diagram, from a hardware perspective, of the cloud HMI server 22 of FIG. 2. Specifically, the cloud HMI server 22 may include a processor such as a central processing unit (CPU) 220 utilized to execute the aforementioned background tasks. The cloud HMI server 22 may also include communication interfaces, such as universal serial bus (USB), RS-232/485, dual Ethernet, control area network (CAN) bus (not shown), high-definition multimedia interface (HDMI) and secure digital (SD) slot, for executing the aforementioned communication interface tasks.

Each communication interface mentioned above has its specific use. Specifically speaking, USB and SD slots may be configured to receive, for example, a thumb drive/disk as extended storage. RS-232/485 and CAN buses may be configured to communicate with, for example, the machine controller 24 to exchange data and send commands. In the embodiment, the Ethernet of each cloud HMI server 22 includes two Ethernet interfaces: one to communicate with the interactive panel 21 and the other to connect with the machine controller 24. Either or both of the HDMI interfaces may act as a direct video output interface of the cloud HMI server 22 to transmit audio and video signals.

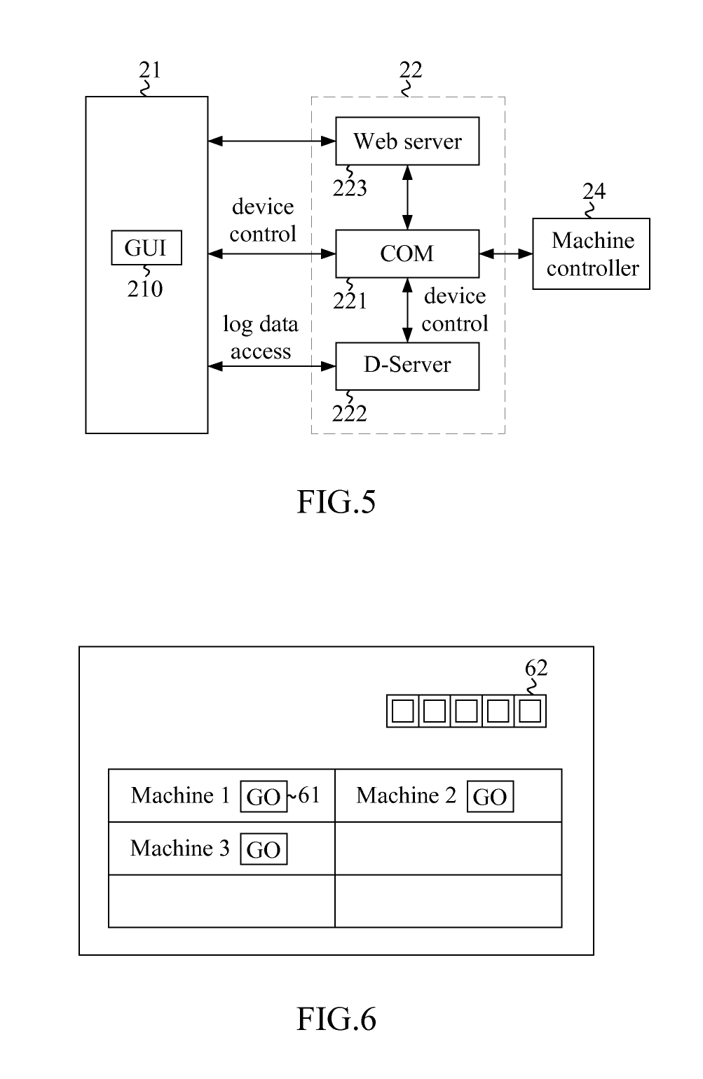

FIG. 5 shows a detailed block diagram, from a software perspective, of the cloud HMI server 22 of FIG. 2. Specifically, the cloud HMI server 22 includes a communication (COM) module 221 configured to communicate with the machine controller 24 and provide service to the interactive panel 21. Accordingly, the interactive panel 21 may read from or write to the machine controller 24 via the COM module 24. Therefore, the use of the COM module 24 may simplify protocols/processes to control and communicate with the machine controller 24.

The cloud HMI server 22 also includes a data server (D-server) module 222 configured to be responsible for alarm logging, data logging, macro function and providing an interface for a cloud HMI software application (App) located in the interactive panel 21 to read log data from the cloud HMI server 22. The cloud HMI server 22 may further include a web server 223 that is used to provide a web interface, via which an engineer can configure system settings. The web server 223 may also process upload/download commands to/from the interactive panel 21.

The cloud HMI App mentioned above, in the embodiment, constructs a graphical user interface (GUI) 210 on the interactive panel 21 to handle foreground components of a project, and then display data of the machine controller 24 and log data from the cloud HMI server 22 in visual format. The cloud HMI App also controls the machine controller 24 via the COM module 221. As used herein, the process of transferring a custom design visual interface from the cloud HMI server 22 to the interactive panel 21 is called an upload and the custom design visual interface is called a project.

In the embodiment, according to that shown in FIG. 5, the interaction between the interactive panel 21 and the cloud HMI server 22 may be conducted by the following two protocols: a device control protocol and/or a log data access protocol.

The device control protocol is in charge of conducting protocol conversion between the machine controller 24 and the GUI (or the interactive panel) 210. The device control protocol accepts commands from the GUI 210 or D-server 222, and converts the commands, which are then sent to the machine controller 24. The commands may, for example, be categorized into two classes: setting and reading registers/coil. After the machine controller 24 replies, the device control protocol converts data and then sends them (e.g., the converted data) to the GUI 210 or the D-server 222.

The log data access protocol defines how the GUI 210 accesses alarm and data (including accessible objects, length, etc.) maintained by the cloud HMI server 22. The log data access protocol also defines how a response is generated and the content of the response for data update event(s).

According to the cloud HMI system 2 (FIG. 2) disclosed herein and discussed above, an operator is capable of remotely monitoring and controlling some or all machines (via associated machine controllers 24) through a single interactive panel 21. Alternatively, one or more machines may be monitored and controlled through multiple interactive panels 21.

As user projects (i.e., custom design visual interfaces) are stored in the cloud HMI servers 22, and then transferred (i.e., uploaded) to requesting interactive panels 21, the (normally difficult) synchronization among the custom design visual interfaces on the interactive panels 21 may thus be eliminated according to an aspect of the embodiment. Different characteristics of the machine controllers 24 may thus be transparent to the interactive panel 21.

FIG. 6 shows an exemplary search interface of the GUI 210 of FIG. 5. When the interactive panel 21 is activated, an operator may initiate an upload command by clicking “GO” button 61 in the search interface. After an associated project is uploaded, the visual format is set as configured by the project, and the interactive panel 21 may communicate with the cloud HMI server 22 to obtain data, which are then displayed on the screen of the interactive panel 21.

As mentioned above, one single interactive panel 21 can monitor and control multiple cloud HMI servers 22, one of which may be selected by clicking one “slot” 62 as shown in FIG. 6, thereby changing the visual interface to a corresponding cloud HMI server 22.

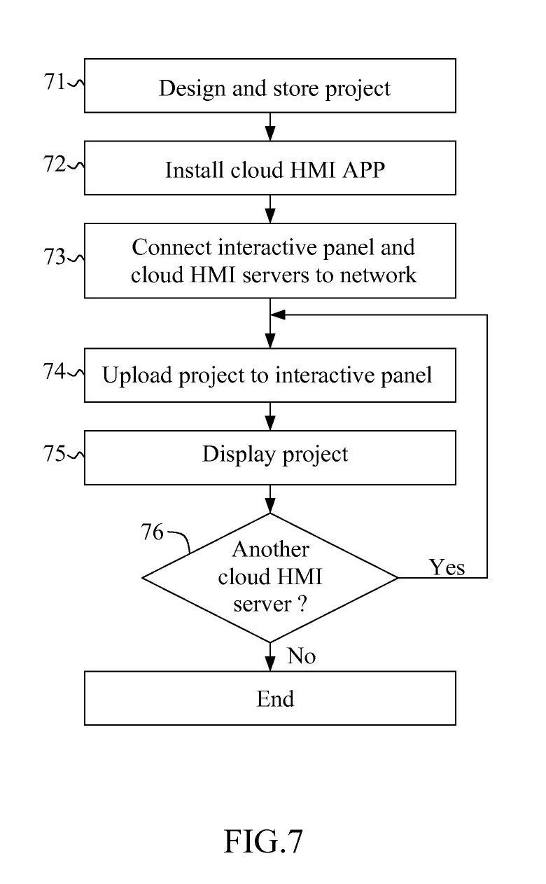

FIG. 7 shows a flow diagram illustrative of operation sequence of the cloud HMI system 2 of FIG. 2. In step 71, projects are designed and then stored in the cloud HMI servers 22. In step 72, a cloud HMI App is installed in the interactive panel 21. Subsequently, in step 73, the interactive panel 21 and the cloud HMI servers 22 are connected to the network 23. In step 74, the cloud HMI App is opened on the interactive panel 21, a cloud HMI server is searched, and a project is uploaded from the cloud HMI server 22 to the interactive panel 21 by clicking an associated “GO” button. Afterwards, in step 75, the user project with real time data are displayed on the interactive panel 21. If another cloud HMI server 22 need be connected (step 76), a different “slot” is clicked and the flow goes back to step 74.

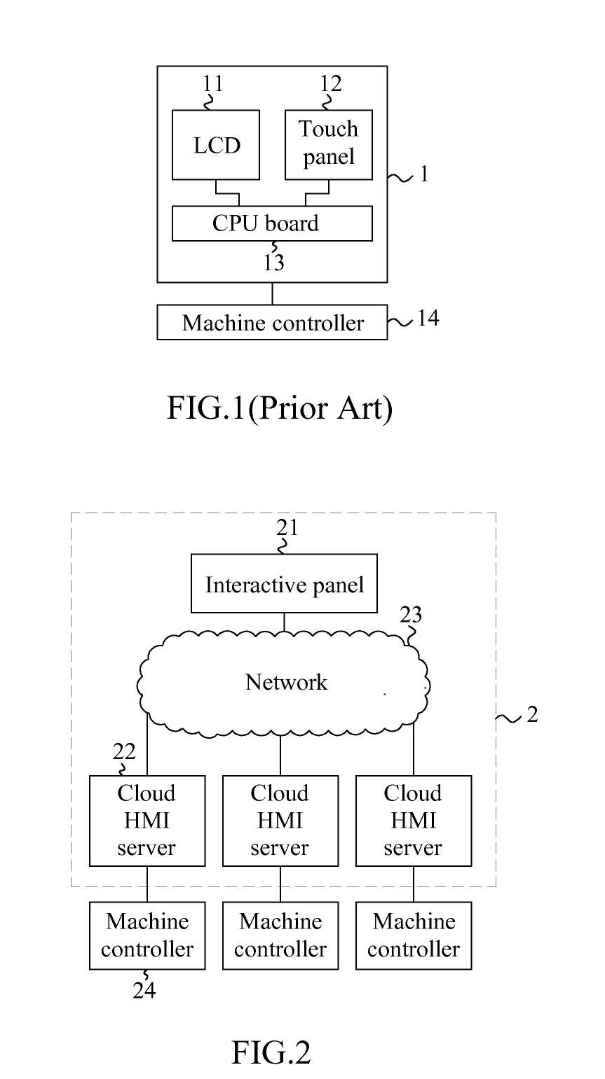

According to the embodiment discussed above, as one interactive panel 21 may be connected to multiple cloud HMI servers 22 to manipulate several machines, LCDs and touch panels may therefore be saved, compared with a conventional. system (e.g., FIG. 1) that requires an LCD and touch panel set for each HMI server. Moreover, an operator need not go to each machine and operate dedicated HMI installed near or in each machine. Instead, the operator in the embodiment is able to remotely monitor and control the cloud HMI servers 22 and associated machines. Alternatively, the embodiment allows several operators to be connected with one cloud HMI server 22 and an associated machine.

As HMI servers are commonly installed to endure relatively extreme environments, such as those less than optimal for LCDs and touch panels, the system 2 as disclosed in the embodiment can offer a more suitable solution, e.g., for harsh environments. By operation of the invention the LCDs 211 and touch panels 212 are no longer disposed in the cloud HMI servers 22 that come near the machines subjected to harsh environments. To the contrary, in a conventional system (FIG. 1), the LCDs and touch panels are disposed in the HMI that is subjected to harsh environments.

Furthermore, in the embodiment, the interactive panel 21 is connected with the cloud HMI server 22 by the uploading of project (i.e., custom design visual interface(s)), and the cloud HMI server 22 is selected by switching among slots. To the contrary, in a conventional system, a dedicated project is downloaded into HMI 1 (FIG. 1) to perform communication and switching.

Although specific embodiments have been illustrated and described, it will be appreciated by those skilled in the art that various modifications may be made without departing from the scope of the present invention, which is intended to be limited solely by the appended claims.

What is claimed is:

1. A cloud human-machine interface (HMI) system, comprising:
an interactive panel configured to execute user interface tasks;
at least one cloud HMI server configured to execute communication interface tasks and background tasks; and
a network, via which the interactive panel and the cloud HMI server are connected.

2. The system of claim 1, wherein the network comprises a wired computer network or a wireless computer network.

3. The system of claim 1, further comprising at least one machine controller respectively connected to an associated cloud HMI server.

4. The system of claim 1, wherein the interactive panel comprises:
a display;
an input device; and
a processing board coupled with the display and the input device, whereby the display and input device enable one or more of a user observing a status of machine operation and sending commands to control at least one machine.

5. The system of claim 4, wherein the display comprises a liquid crystal display (LCD), the input device comprises a touch panel, and the processing board comprises a central processing unit (CPU) board.

6. The system of claim 1, wherein the cloud HMI server comprises a CPU utilized to execute the background tasks.

7. The system of claim 6, wherein the cloud HMI server further comprises at least one communication interface for executing the communication interface tasks.

8. The system of claim 7, wherein the at least one communication interface comprises one or more of the following: universal serial bus (USB), RS-232/485, dual Ethernet, control area network (CAN) bus, high-definition multimedia interface (HDMI) and secure digital (SD) slot.

9. The system of claim 8, wherein said dual. Ethernet comprises two Ethernet interfaces: one enabling communication with the interactive panel and the other facilitating connection with a machine controller.

10. The system of claim 3, wherein the cloud HMT server comprises:
a communication (COM) module configured to communicate with the machine controller and provide service to the interactive panel; and
a data server (D-server) module configured to be responsible for alarm logging, data logging, macro function and providing an interface for a cloud HMI software application (App) located in the interactive panel to read log data from the cloud HMI server.

11. The system of claim 10, wherein the cloud HMI server further comprises:
a web server configured to provide a web interface, via which an engineer can configure system settings or to process upload/download commands to/from the interactive panel.

12. The system of claim 10, wherein:
the interactive panel comprises a graphical user interface (GUI) constructed by the cloud HMI App; and
the cloud HMI App handles foreground components of a project and then displays data of the machine controller and log data from the cloud HMI server in visual format; or controls the machine controller via the COM module.

13. The system of claim 12, wherein interaction between the interactive panel and the cloud HMI server can be conducted by the following two protocols: a device control protocol and a log data access protocol.

14. The system of claim 13 wherein:
the device control protocol is in charge of conducting protocol conversion between the machine controller and the GUI; and
the device control protocol accepts commands from the GUI or the D-server, and converts the commands, which are then sent to the machine controller, whereby after the machine controller replies, the device control protocol converts data and then sends them to the GUI or the D-server.

15. The system of claim 12, wherein the GUI comprises at least one “GO” button, which is clicked to initiate an upload command to upload an associated project, by which the visual format is set as configured by the project.

16. The system of claim 15, wherein the GUI further comprises a plurality of slots, one of which is clicked to select an associated cloud HMI server.

17. The system of claim 16, wherein the interactive panel and the cloud HMI server are configured to perform the following:
storing the project in the cloud HMI server;
installing the cloud HMI App in the interactive panel;
connecting the interactive panel and the cloud HMI server to the network;
opening the cloud HMI App on the interactive panel, searching the cloud HMI server, and uploading the project from the cloud HMI server to the interactive panel by clicking an associated “GO” button; and
displaying the project with real time data on the interactive panel.
